(19) United States
(12) Patent Application Publication
(10) Pub. No.: US 2010/0033383 A1
(43) Pub. Date: Feb. 11, 2010

(54) MOBILE WIRELESS DEVICE

(75) Inventor: Daisuke Yamamoto, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd, Osaka (JP)

(21) Appl. No.: 11/813,041

(22) PCT Filed: Jan. 6, 2006
(86) PCT No.: PCT/JP2006/300087

§ 371 Date: Jun. 28, 2007

(30) Foreign Application Priority Data
Jan. 7, 2005 (JP) 2005-002425

(51) Int. Cl. H01Q 1/24

(52) U.S. Cl. 343/702

(57) ABSTRACT

To provide a mobile wireless device that ensures high antenna performance and a high antenna gain.

In an antenna configuration that secures a predetermined band with an antenna element 11 and a parasitic element 16, the antenna element 11 is mounted on the inner surface of an upper enclosure case 3 and the parasitic element 16 is mounted on the outer surface of the upper enclosure case 3 and arranged between the upper enclosure case 3 and a panel 4 mounted on the outer surface of the upper enclosure case 3 so as to increase the distance from the parasitic element 16 to a metallic component in an enclosure 1. By arranging the parasitic element 16 operating as a waveguide in a position in a more distant position from a human body than the antenna element 11 in a conversation state, radiation toward the opposite side of the human body is enhanced.

### TECHNICAL FIELD

The present invention relates to a mobile wireless device featuring sophisticated antenna performance and a high antenna gain effect.

### BACKGROUND ART

In recent years, mobile wireless devices have been in widespread use. Compact, lightweight and well-designed products have been required by more and more users. Antennas that are compact, lightweight and full built-in type for mobile wireless devices have been also required. Incorporating an antenna in an enclosure brings the antenna close to an internal circuit board or a metallic component thus resulting in substantial degradation of antenna performance. The antenna performance is likely to degrade as the enclosure accommodating an antenna becomes low-profile. It is a key challenge to provide a sophisticated antenna housed in a low-profile enclosure.

An example of a built-in antenna will be described using one shown in FIG. 11.

As shown in FIG. 11, a mobile wireless device 101 arranges, inside an enclosure 102, an antenna element 104 that receives power from a power feeding part 103 and a parasitic element 104 away from the antenna element 104 by a predetermined distance. The mobile wireless device 101 provides wider bandwidth and lower SAR by way of resonance of the antenna element 104 and parasitic element 105.

This antenna causes the parasitic element 105 to operate as a waveguide by arranging the antenna element 104 and the parasitic element 105 in positions shown in FIG. 12 and enhances the antenna gain by adjusting the radiation directivity to a direction different from the direction of a human body 107 (arrow direction in FIG. 12) by way of the effect of the parasitic element 105 (for example, refer to Patent Reference 1).

Patent Reference 1: JP-A-2003-243916

### DISCLOSURE OF THE INVENTION

As the enclosure of a mobile wireless device becomes more compact and lower-profile, an antenna in an enclosure is arranged more closely to a circuit board or a metallic component in the enclosure. This results in the narrower bandwidth and degraded performance of an antenna.

As shown in FIG. 12, the tip of the enclosure 102 of the mobile wireless device 101 is likely to have a curved shape from the constraints of design. When the parasitic element 105 operating as a waveguide is arranged on the tip of the enclosure 102, the radiating direction of an antenna is upward from the enclosure 102, that is, the direction of an arrow shown in FIG. 12. As a result, it is impossible to set the antenna directivity toward the opposite side of the human body thus the influence of the human body causes degradation of antenna gain.

The invention has been accomplished in view of the foregoing circumstances. An object of the invention is to provide a mobile wireless device that ensures high antenna performance and a high antenna gain without changing the thickness of an enclosure.

### <Means for Solving the Problems>

In order to attain the above object, the invention provides a mobile wireless device comprising: an enclosure composed of a dielectric material; an antenna element provided inside the enclosure; a panel composed of a dielectric material mounted outside the enclosure; and a parasitic element arranged outside the enclosure operating as a waveguide whose electrical length is about half the wavelength; characterized in that the antenna element and the parasitic element are arranged on the other side of the user in a voice communication state.

With this configuration, the parasitic element is arranged away from a metallic component or a circuit board thus delivering high antenna performance. The parasitic element is arranged in a more distant position from the user's body than the antenna and operates as a waveguide, which ensures a high antenna gain.

The invention provides a mobile wireless device comprising: an enclosure composed of a dielectric material; an antenna element provided outside the enclosure; a panel composed of a dielectric material mounted outside the enclosure; and a parasitic element arranged outside the enclosure operating as a waveguide whose electrical length is about half the wavelength; characterized in that the antenna element and the parasitic element are arranged on the other side of the user in a voice communication state.

With this configuration, the antenna element is arranged away from a metallic component or a circuit board thus delivering higher antenna performance.

The invention provides a mobile wireless device characterized in that the antenna element is mounted on the outer surface of the enclosure and arranged between the enclosure and the panel.

This configuration reduces the electric length of the antenna element thus downsizing the antenna.

The invention provides a mobile wireless device characterized in that the antenna element is mounted on the inner surface of the enclosure and arranged between the enclosure and the panel.

With this configuration, the same antenna performance is provided irrespective of the material of a panel by adjusting the antenna element length to an electric length corresponding to a panel composed of a different material.

The invention provides a mobile wireless device characterized in that the parasitic element is mounted on the outer surface of the enclosure and arranged between the enclosure and the panel.

This configuration reduces the electric length of the parasitic element thus downsizing the parasitic element.

The invention provides a mobile wireless device characterized in that the parasitic element is mounted inside the panel and arranged between the enclosure and the panel.

With this configuration, the same antenna performance is provided irrespective of the material of a panel by adjusting the parasitic element length to an electric length corresponding to a panel composed of a different material.

The invention provides a mobile wireless device characterized in that the parasitic element is planar and includes a hole inside and that a conductive screw for fixing the panel is inserted from the panel to the enclosure to penetrate the interior of the parasitic element.

With this configuration, it is possible to provide a lightweight parasitic element. It is also possible to adjust the resonance frequency caused by the parasitic element as well as reduce the electric length of a parasitic element compared with a state where a screw is not used thus downsizing the parasitic element by adjusting the length and tightening stages of a screw penetrating the interior of the parasitic element

The invention provides a mobile wireless device characterized in that the parasitic element forms a portion of the panel.

With this configuration, it is possible to keep more distance from a parasitic element to a metallic component or a circuit board in the enclosure. By arranging a surface including a parasitic element outward, it is possible to reduce losses caused by a dielectric material and deliver higher antenna performance.

The invention provides a mobile wireless device characterized in that the antenna element receives balanced power.

With this configuration, it is possible to reduce the influence of the user's hand or body thus ensuring a high antenna gain.

The invention provides a mobile wireless device characterized in that the antenna element receives imbalanced power.

With this configuration, it is possible to secure a wide bandwidth thus ensuring high antenna performance.

The invention provides a mobile wireless device characterized in that the panel is detachable from the enclosure.

With this configuration, it is possible for the user to mount or remove a panel as required thus improving the design applicability.

A mobile wireless device according to the invention provides the effects of ensuring high antenna performance and a high antenna gain by arranging a parasitic element operating as a waveguide between a panel mounted outside an enclosure and the enclosure.

### BRIEF DESCRIPTION OF THE DRAWINGS

FIG. 1 is a front view of a mobile wireless device according to the first embodiment of the invention;

FIG. 2 is an experiment result of the mobile wireless device according to the first embodiment of the invention;

FIG. 3(a) is a general side view of a mobile wireless device with a parasitic element mounted inside an enclosure;

FIG. 3(b) is a graph showing the radiation directivity of a mobile wireless device with a parasitic element mounted in an enclosure;

FIG. 4(a) is a general side view of a mobile wireless device according to the first embodiment with a parasitic element mounted outside an enclosure;

FIG. 4(b) is a graph showing the radiation directivity of the mobile wireless device according to a first embodiment with a parasitic element mounted outside an enclosure;

FIG. 5 is a front view of the configuration of a mobile wireless device according to the second embodiment of the invention;

FIG. 6 a is front view of the configuration of a mobile wireless device according to the third embodiment of the invention;

FIG. 7 is a front view of the configuration of a mobile wireless device according to the fourth embodiment of the invention;

FIG. 8 is a front view of the configuration of a mobile wireless device according to the fifth embodiment of the invention;

FIG. 9 is a front view of the configuration of a mobile wireless device according to the sixth embodiment of the invention;

FIG. 10 is a front view of the configuration of a mobile wireless device according to the seventh embodiment of the invention;

FIG. 11 is a front view of the antenna configuration of a related art mobile wireless device; and

FIG. 12 is a side view of the tip of an enclosure in a conversation state showing the antenna configuration of a related art mobile wireless device.

### DESCRIPTION OF REFERENCE NUMERALS AND SIGNS

1: Upper enclosure

2: Upper enclosure cover

3: Upper enclosure case

4: Panel

5: Lower enclosure

11: Antenna element

12: Feeding point

16, 17, 19, 21, 24: Parasitic element

18, 20: Antenna element

23: Screw hole

### BEST MODE FOR CARRYING OUT THE INVENTION

The mobile wireless device according to embodiments of the invention will be described referring to drawings.

### First Embodiment

A mobile wireless device according to the first embodiment of the invention will be described.

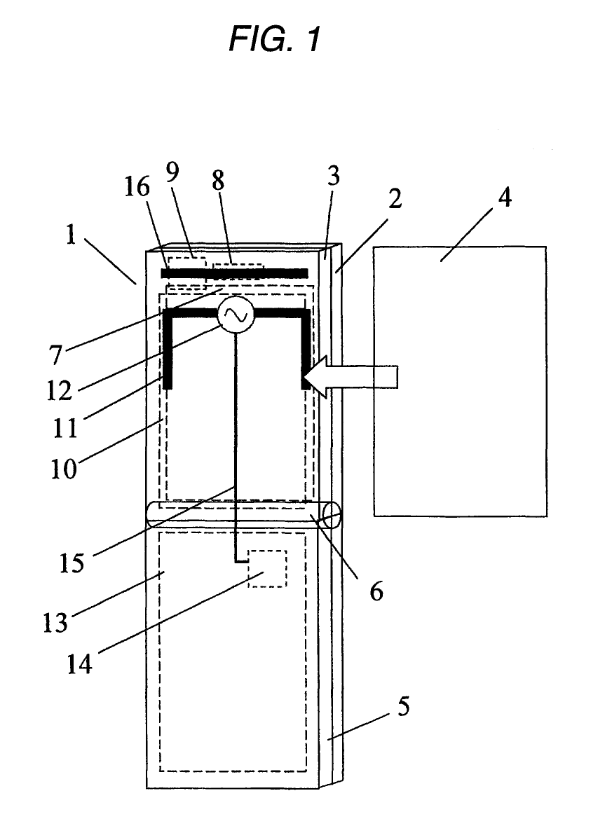

FIG. 1 is a front view of a mobile wireless device according to the first embodiment of the invention.

As shown in FIG. 1, an upper enclosure 1 constituting the enclosure of the mobile wireless device is composed of an upper enclosure cover 2 and an upper enclosure case 3 and a panel 4 is mounted on the upper enclosure 1. The upper enclosure 1 is coupled to a lower enclosure 5 and rotates about a hinge 6 that constitutes the coupling part and thus opens/closes the upper enclosure 1 and the lower enclosure 5. In a voice communication state, the upper enclosure cover 2 of the upper enclosure 1 is arranged on the user's side where it comes into contact with the human body. The upper enclosure case 3 is arranged on the side opposite to the user's side where it does not come into contact with the human body.

The upper enclosure case 3 constituting the upper enclosure 1 is formed of a non-conductive dielectric material such as an ABS resin. The upper enclosure case 3 has a length of about 100 mm, a width of about 50 mm, and a thickness of about 1 mm. The panel 4 is formed of a non-conductive dielectric material such as an ABS resin and has a thickness of about 1 mm. The panel 4 can be mounted or removed and replaced with spare as required for example by the user of the mobile wireless device.

Inside the upper enclosure 1 are arranged an LCD 7, a receiver 8, a camera 9 and the like, which are connected to a circuit board 10. On the circuit board 10 is arranged a feeding point 12 of an antenna element 11. Inside the lower enclosure is a circuit board 13. On the circuit board 13 is arranged a radio circuit 14, which is connected to the feeding point 12 via a coaxial cable 15. The antenna element 11 is mounted on the inner surface of the upper enclosure case 3 of the upper enclosure 1. The antenna element 11 is formed of a conductive material such as copper or aluminum and connected to the feeding point 12 via a feeding pin or the like. The antenna element 11 is for example a single-wavelength dipole antenna. The antenna element 11 has an effective length of about 150 mm when used in the 2 GHz band. In case the antenna element 11 cannot be mounted in the lateral direction of the upper enclosure 1, the tip of the antenna element 11 is bent in the longitudinal direction of the upper enclosure 1.

On the upper enclosure case 3 is mounted a parasitic element 16 at a predetermined distance from the antenna element 11. The parasitic element 16 is made of a conductive material such as copper or aluminum and arranged between the upper enclosure case 3 and the panel 4. The parasitic element 16 has an effective length of about 75 mm when used in the 2 GHz band. In case the parasitic element 16 cannot be mounted in the lateral direction of the upper enclosure 1, the tip of the parasitic element 16 is bent in the longitudinal direction of the upper enclosure 1.

Operation of thus configured mobile wireless device will be described.

Radio waves are radiated from the antenna element 11 that receives power at the feeding point 12 and the parasitic element 16 spatially coupled to the antenna element 11. For example, assuming the use in the 2 GHz band of W-CDMA system, a transmission frequency band of 1920 to 1980 MHz and the reception frequency band of 2110 to 2170 are reserved respectively by the resonance of the antenna element 11 and the resonance of the parasitic element 16. The parasitic element 16 is coupled to the radiation from the antenna element 11 and operates as a waveguide to guide the entire radiation of the antenna toward the parasitic element 16.

In this way, according to the mobile wireless device of the first embodiment of the invention, it is possible to reduce the electric length of the parasitic element 16 and downsize the same by mounting the parasitic element 16 on the outer surface of the upper enclosure case 3 and arranging the parasitic element 16 between the upper enclosure case 3 and the panel 4. The parasitic element 16 arranged between the upper enclosure case 3 and the panel 4 so that it is free from damage and is invisible from outside when in use.

It is possible to increase the distance from the parasitic element 16 to a metallic component such as the circuit board 10, receiver 8 and camera 9 in the upper enclosure 1 by 1 mm, the thickness of the upper enclosure case 3. This ensures high antenna performance without adding to the thickness of the upper enclosure 1.

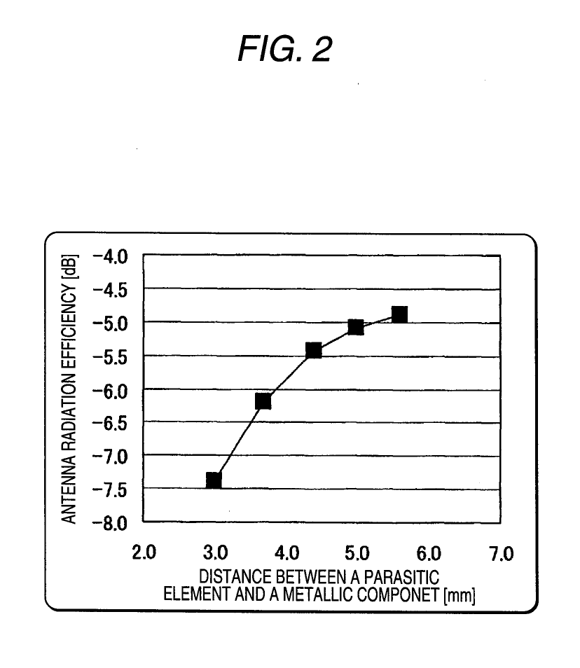

FIG. 2 shows a change in the antenna radiation efficiency observed when the distance from the parasitic element 16 to a metallic component such as the circuit board 10 is changed. As understood from FIG. 2, by placing the parasitic element 16 away from a metallic component such as the circuit board 10, the antenna radiation efficiency is improved. In case the parasitic element 16 is arranged closer to the metallic components, the antenna radiation efficiency will drop.

For example, in case the distance to a metallic component is 4.5 mm with the parasitic element 16 mounted on the inner surface of the upper enclosure case 3, it is possible to increase the distance from the parasitic element 16 to a metallic component by 1 mm, the thickness of the upper enclosure case 3, by mounting the parasitic element 16 on the inner surface of the upper enclosure case 3. The resulting distance is 5.5 mm which improves the antenna radiation efficiency by 0.5 dB.

By arranging the parasitic element 16 operating as a waveguide on the side opposite to the user with respect to the position of the antenna element 11 in a conversation state, it is possible to enhance radiation toward the opposite side of the human body thus ensuring a high antenna gain.

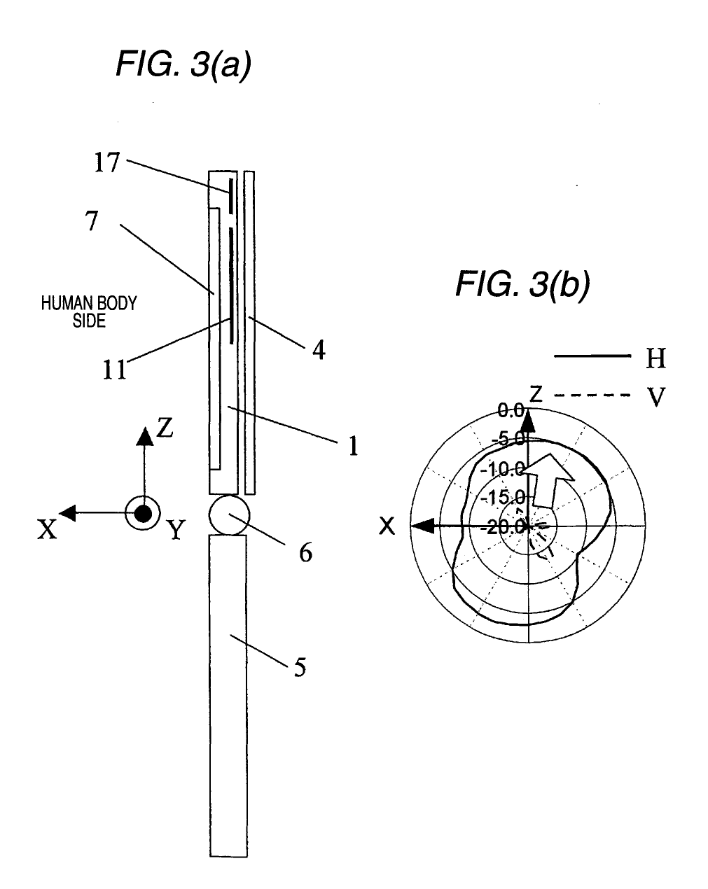

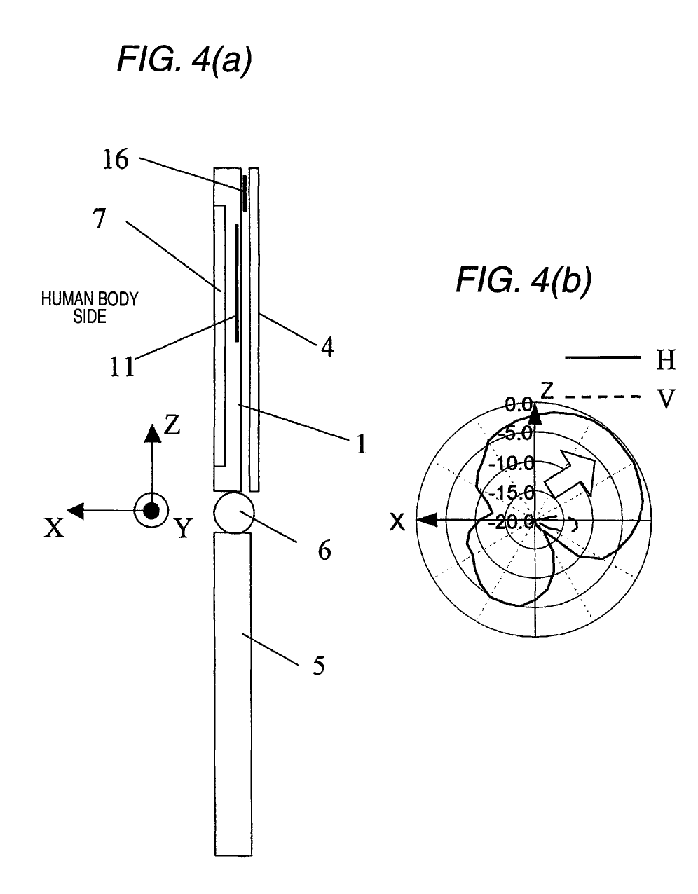

FIG. 3 is a side view of a mobile wireless device with a parasitic element 17 mounted on the inner surface of the upper enclosure 1 and the corresponding radiation directivity in the Z-X plane. FIG. 4 is a side view of a mobile wireless device according to the first embodiment of the invention with the parasitic element 16 mounted on the inner surface of the upper enclosure 1 and arranged between the upper enclosure 1 and the panel 4 and the corresponding radiation directivity in the Z-X plane.

As shown in FIG. 3(a), when the parasitic element 17 is mounted on the inner surface of the upper enclosure 1, the antenna element 11 and the parasitic element 17 are placed in the same plane and the antenna directivity is upward from the upper enclosure 1 as shown by the arrow in FIG. 3(b). On the other hand, as shown in FIG. 4(b), when the parasitic element 16 is mounted on the outer surface of the upper enclosure 1, the parasitic element 16 is arranged away from the human body than the antenna element 11 in a conversation state. This enhances radiation toward the opposite side of the human body as shown by the arrow in FIG. 4(b) thereby reducing the influence of the human body and improving the antenna gain.

### Second Embodiment

A mobile wireless device according to the second embodiment of the invention will be described.

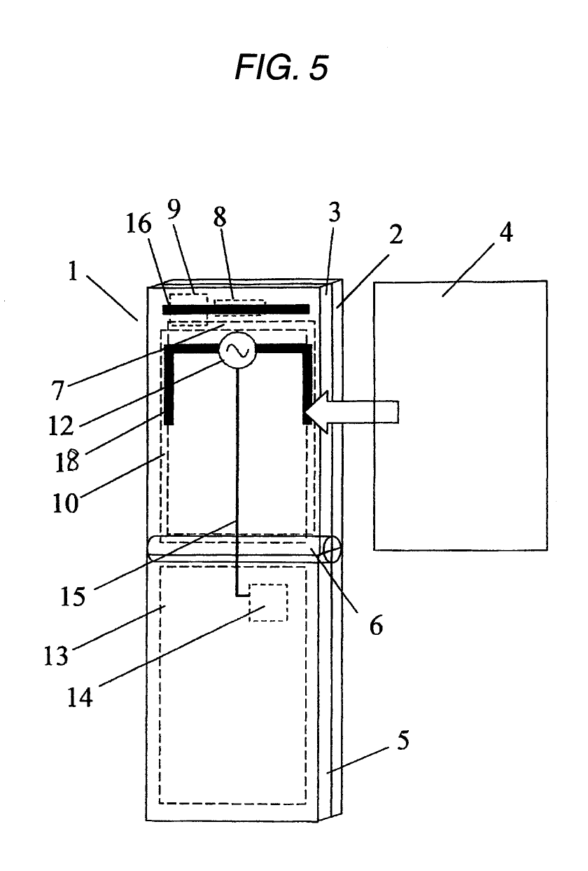

FIG. 5 is a front view of a mobile wireless device according to the second embodiment of the invention.

A same component as one in the first embodiment is given a same sign and the corresponding description is omitted. The operation of an antenna is the same as that in the first embodiment so that the corresponding description is omitted.

As understood from the configuration shown in FIG. 5, in the mobile wireless device, an antenna element 18 is mounted on the outer surface of an upper enclosure case 3, runs along the upper enclosure case 3 and receives power at the feeding point 12. In the second embodiment also, the same advantage as the first embodiment is obtained. In particular, in this example, it is possible to reduce the electric length of the antenna element 18 and downsize the same by arranging the antenna element 18 between the upper enclosure case 3 and a panel 4. It is possible to ensure high antenna performance by placing a metallic component in the upper enclosure 1 away from the antenna element 18.

### Third Embodiment

A mobile wireless device according to the third embodiment of the invention will be described.

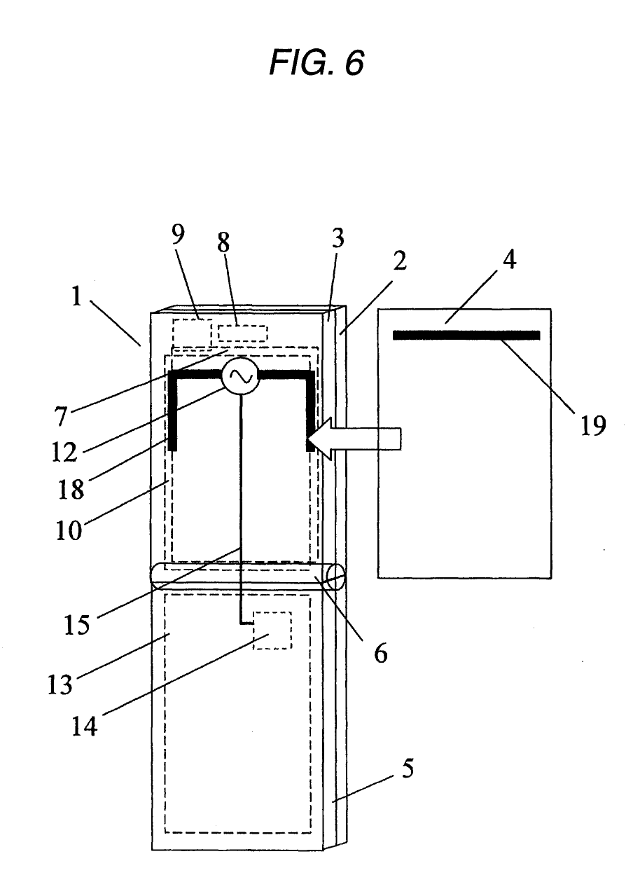

FIG. 6 is a front view of a mobile wireless device according to the third embodiment of the invention.

A same component as one in the first or second embodiment is given a same sign and the corresponding description is omitted. The operation of an antenna is the same as that in the first embodiment so that the corresponding description is omitted.

As understood from the configuration shown in FIG. 6, in the mobile wireless device, a parasitic element 19 is mounted on the inner surface of a panel 4 and arranged between an upper enclosure case 3 and the panel 4.

In this way, according to the third embodiment of the invention, it is possible to increase the distance from the parasitic element 19 to a metallic component in an upper enclosure 1 by arranging the parasitic element 19 on the inner surface of the panel 4 thus ensuring higher antenna performance.

By mounting the parasitic element 19 on the panel 4, it is possible to individually adjust the physical length of the parasitic element 19 to a panel composed of a different material. This obtains the impedance characteristic that resonates at the same resonance frequency irrespective of the panel 4 composed of a different material, thereby obtaining the same antenna performance.

### Fourth Embodiment

A mobile wireless device according to the fourth embodiment of the invention will be described.

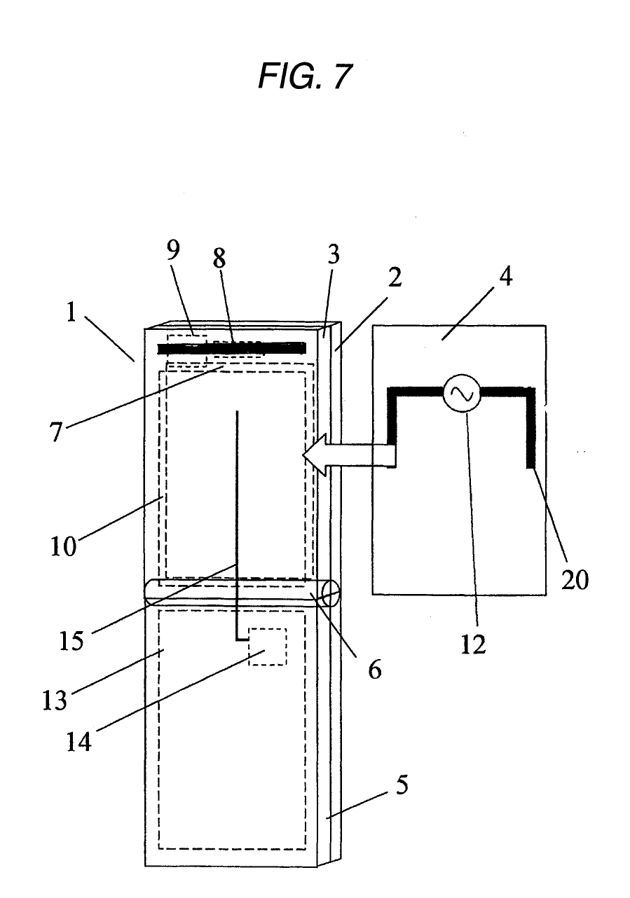

FIG. 7 is a front view of a mobile wireless device according to the fourth embodiment of the invention.

A same component as one in the first, second or third embodiment is given a same sign and the corresponding description is omitted. The operation of an antenna is the same as that in the first embodiment so that the corresponding description is omitted.

As understood from the configuration shown in FIG. 7, in the mobile wireless device, an antenna element 20 is mounted on the inner surface of a panel 4 and arranged between an upper enclosure case 3 and the panel 4.

In this way, according to the fourth embodiment of the invention, it is possible to increase the distance from the antenna element 20 to a metallic component in an upper enclosure 1 by arranging the antenna element 20 on the inner surface of the panel 4, thus ensuring higher antenna performance. By mounting the antenna element 20 on the panel 4, it is possible to individually adjust the physical length of the antenna element 20 to the panel 4 composed of a different material. This obtains the impedance characteristic that resonates at the same resonance frequency irrespective of the panel 4 composed of a different material, thereby obtaining the same antenna performance.

### Fifth Embodiment

A mobile wireless device according to the fifth embodiment of the invention will be described.

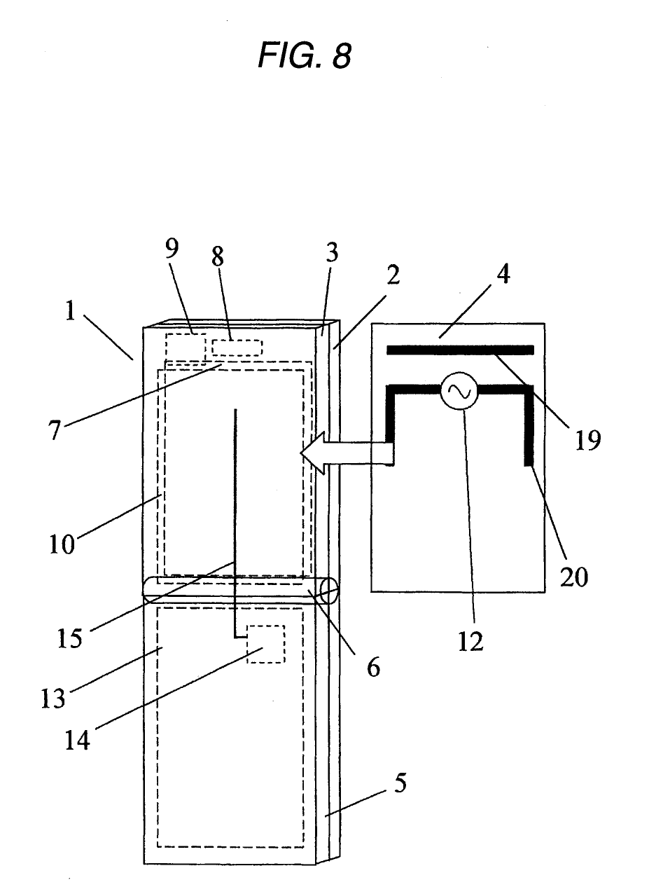

FIG. 8 is a front view of a mobile wireless device according to the fifth embodiment of the invention.

A same component as one in the first to fourth embodiments is given a same sign and the corresponding description is omitted. The operation of an antenna is the same as that in the first embodiment so that the corresponding description is omitted.

As understood from the configuration shown in FIG. 8, in the mobile wireless device, a parasitic element 19 and an antenna element 20 are mounted on the inner surface of a panel 4 and arranged between an upper enclosure case 3 and the panel 4.

In this way, according to the fifth embodiment of the invention, it is possible to increase the distance from the parasitic element 19 and antenna element 20 to a metallic component in an upper enclosure 1 by arranging the parasitic element 19 and the antenna element 20 on the inner surface of the panel 4 thus ensuring higher antenna performance. By mounting the parasitic element 19 and the antenna element 20 on the panel 4, it is possible to individually adjust the physical length of the parasitic element 19 or the antenna element 20 to a panel 4 composed of a different material. This obtains the impedance characteristic that resonates at the same resonance frequency irrespective of the panel 4 composed of a different material, thereby obtaining the same antenna performance.

### Sixth Embodiment

A mobile wireless device according to the sixth embodiment of the invention will be described.

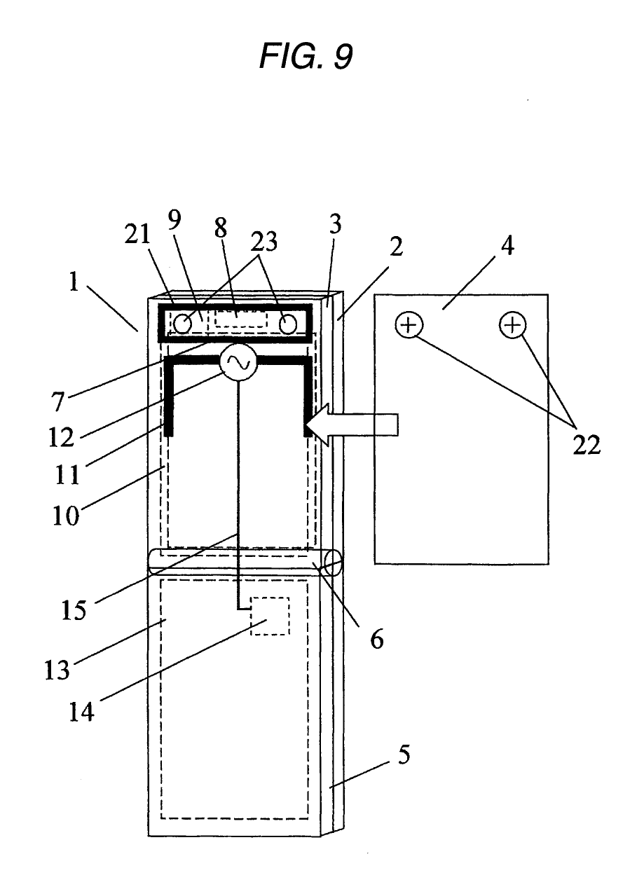

FIG. 9 is a front view of a mobile wireless device according to the sixth embodiment of the invention.

A same component as one in the first to fifth embodiments is given a same sign and the corresponding description is omitted. The operation of an antenna is the same as that in the first embodiment so that the corresponding description is omitted.

As understood from the configuration shown in FIG. 9, in the mobile wireless device, a parasitic element 21 is planar and includes a hole inside. A conductive screw 22 for fixing a panel 4 is inserted from the panel 4 to a screw hole 23 provided on an upper enclosure case 3 to penetrate the interior of the planar parasitic element 21 including a hole. In this way, b using a planar parasitic element 21 including a hole inside, a lightweight design is made possible. By inserting a conductive screw 22 into the parasitic element 21 having a hole, it is possible to lower the resonance frequency caused by the parasitic element 21. Assuming the use in the same frequency band, it is possible to reduce the physical length of the parasitic element 21 and adjust the resonance frequency of the parasitic element 21 thus downsizing the parasitic element 21.

Further, by increasing the length of the conductive screw 22, the resonance frequency of the parasitic element 21 can be lowered and the physical length of the parasitic element 21 can be reduced to downsize the parasitic element 21. By adjusting the tightening stages of the conductive screw 22 and changing the position of the parasitic element 21 in the thickness direction of the upper enclosure 1, it is possible to adjust the resonance frequency of the parasitic element 21.

In this way, according to the sixth embodiment of the invention, it is possible to provide a lightweight and compact parasitic element 21 by designing the parasitic element 21 into a planar shape, making a hole therein and passing the conductive screw 22 for fixing the panel 4 into the hole.

### Seventh Embodiment

A mobile wireless device according to the seventh embodiment of the invention will be described.

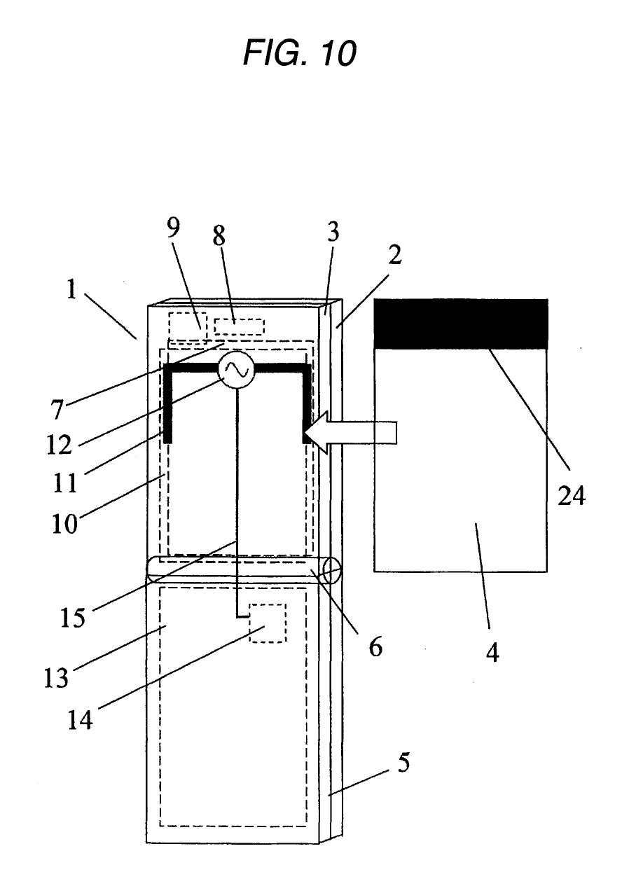

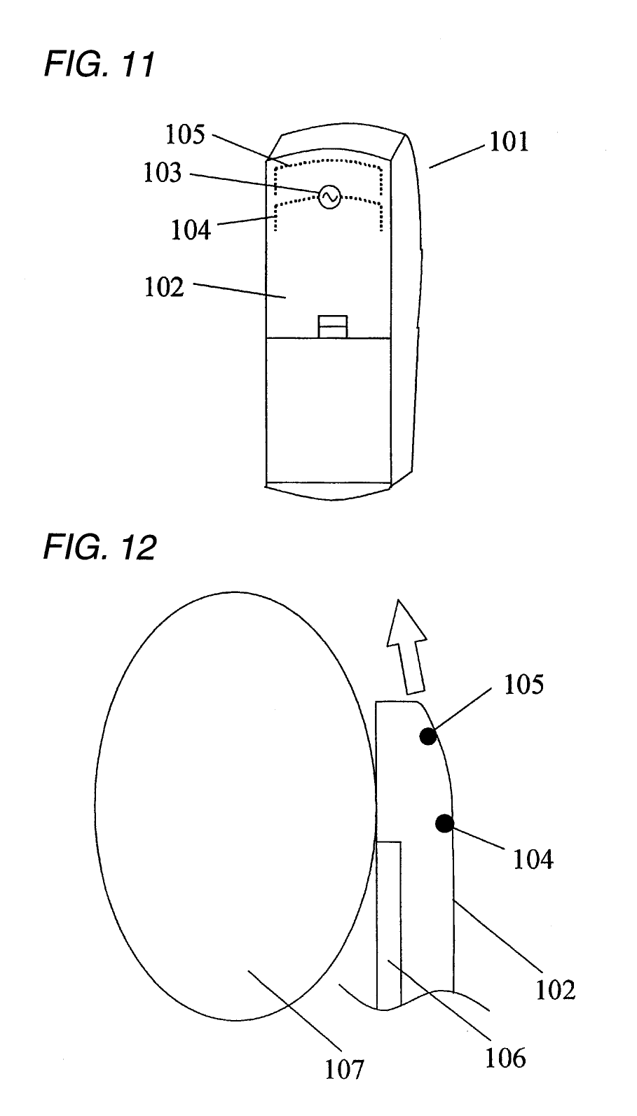

FIG. 10 is a front view of a mobile wireless device according to the seventh embodiment of the invention.

A same component as one in the first to fifth embodiments is given a same sign and the corresponding description is omitted. The operation of an antenna is the same as that in the first embodiment so that the corresponding description is omitted.

As shown in FIG. 10, in the mobile wireless device, a parasitic element 24 is a portion of a panel 4. By providing the parasitic element 24 as a portion of the panel 4 and increasing the distance from the parasitic element 24 to a metallic component in an upper enclosure 1, it is possible to ensure high antenna performance. By arranging the parasitic element 24 as a portion of the panel 4 on the outer surface of the panel 4, it is possible to reduce the loss caused by a dielectric as a material of the panel 4 thus ensuring higher antenna performance.

In this way, with the mobile wireless device according to the seventh embodiment, it is possible to ensure higher antenna performance and eliminate the need for another member for composing the parasitic element 24, thus improving the assembling properties and reducing the overall cost.

While the antenna element described as an example is a balanced feeding type dipole antenna in the foregoing embodiments, a monopole antenna as an imbalanced feeding type provides a similar effect.

While the mobile wireless device described in the foregoing embodiments is a collapsible mobile wireless device where the upper and lower enclosures are rotatable about a hinge 6, a rod-shaped mobile wireless device composed of a single enclosure provides a similar effect.

The invention is not limited to the described embodiments but various other embodiments may be practiced within the main point of the invention.

While the invention has been described in detail and referring to specific embodiments, those skilled in the art will recognize that various changes and modifications can be made in it without departing the spirit and scope thereof.

This application is based on Japanese Patent Application No. 2005-002425 filed Jan. 7, 2005, and its content is herein incorporated as a reference.

### INDUSTRIAL APPLICABILITY

The invention is useful as a mobile wireless device that ensures high antenna performance and a high antenna gain by arranging a parasitic element operating as a waveguide between a panel mounted outside an enclosure and the enclosure.

1. A mobile wireless device, comprising:
an enclosure composed of a dielectric material;
an antenna element provided inside said enclosure;
a panel composed of a dielectric material mounted outside said enclosure; and
a parasitic element arranged outside said enclosure operating as a waveguide whose electrical length is about half the wavelength;
wherein said antenna element and said parasitic element are arranged on the other side of the user in a voice communication state; and
said parasitic element is mounted on the outer surface of said enclosure and arranged between said enclosure and said panel.

2. A mobile wireless device comprising:
an enclosure composed of a dielectric material;
an antenna element provided inside said enclosure;
a panel composed of a dielectric material mounted outside said enclosure; and
a parasitic element arranged outside said enclosure operating as a waveguide whose electrical length is about half the wavelength;
wherein said antenna element and said parasitic element are arranged on the other side of the user in a voice communication state, and
said parasitic element is mounted on the inner surface of said panel and arranged between said enclosure and said panel.

3. A mobile wireless device comprising:
an enclosure composed of a dielectric material;
an antenna element provided outside said enclosure;
a panel composed of a dielectric material mounted outside said enclosure; and
a parasitic element arranged outside said enclosure operating as a waveguide whose electrical length is about half the wavelength;
wherein said antenna element and said parasitic element are arranged on the other side of the user in a voice communication state, and
said parasitic element is mounted on the outer surface of said housing and arranged between said enclosure and said panel.

4. A mobile wireless device comprising:
an enclosure composed of a dielectric material;
an antenna element provided outside said enclosure;
a panel composed of a dielectric material mounted outside said enclosure; and
a parasitic element arranged outside said enclosure operating as a waveguide whose electrical length is about half the wavelength;
wherein said antenna element and said parasitic element are arranged on the other side of the user in a voice communication state, and
said parasitic element is mounted on the inner surface of said panel and arranged between said enclosure and said panel.

5. The mobile wireless device according to any one of claims 1 to 4, wherein said antenna element is mounted on the outer surface of said enclosure and arranged between said enclosure and said panel.

6. The mobile wireless device according to any one of claims 1 to 4, wherein said antenna element is mounted on the inner surface of said panel and arranged between said enclosure and said panel.

7. The mobile wireless device according to any one of claims 1 to 4, wherein said parasitic element is planar and includes a hole inside and that a conductive screw for fixing said panel is inserted from said panel to said enclosure to penetrate the interior of said parasitic element.

8. The mobile wireless device according to any one of claims 1 to 4, wherein said parasitic element forms a portion of said panel.

9. The mobile wireless device according to any one of claims 1 to 4, wherein said antenna element receives balanced power.

10. The mobile wireless device according to any one of claims 1 to 4, wherein said antenna element receives imbalanced power.

11. The mobile wireless device according to any one of claims 1 to 4, wherein said panel is detachable from said enclosure.
